(19) United States
(12) Patent Application Publication
(10) Pub. No.: US 2017/0269957 A1
(43) Pub. Date: Sep. 21, 2017

(54) INFORMATION PROCESSING APPARATUS, INFORMATION PROCESSING SYSTEM, NON-TRANSITORY COMPUTER-READABLE RECORDING MEDIUM HAVING STORED THEREIN PROGRAM, AND METHOD FOR PROCESSING INFORMATION

(71) Applicant: FUJITSU LIMITED, Kawasaki-shi (JP)

(72) Inventors: Yoshiharu KAMATA, Yokohama (JP); Norihiko Sakamoto, Yokohama (JP); Masayoshi Utaka, Yokohama (JP)

(73) Assignee: FUJITSU LIMITED, Kawasaki-shi (JP)

(21) Appl. No.: 15/432,206

(22) Filed: Feb. 14, 2017

(30) Foreign Application Priority Data
Mar. 17, 2016 (JP) 2016-053858

(51) Int. Cl. G06F 9/455; G06F 9/44

(52) U.S. Cl. CPC G06F 9/45558; G06F 8/71; G06F 2009/4557

(57) ABSTRACT

An information processing apparatus includes a first determiner, a second determiner, and third determiner. The first determiner determines, when a second virtual machine of a migration destination is generated from a first virtual machine of a migration source, whether a first generating definition representing a specification of the first virtual machine matches a second generating definition representing a specification of the second virtual machine. The second determiner determines whether first version information representing a version of software having been installed in the first virtual machine matches second version information representing a version of software having been installed in the second virtual machine. The third determiner determines, when the first determiner determines that the first generating definition matches the second generating definition and the second determiner determines that the first version information matches the second version information, the second virtual machine has the same configuration as the first virtual machine.

### CROSS-REFERENCE TO RELATED APPLICATIONS

This application is based upon and claims the benefit of priority of the prior Japanese Patent Application No. 2016-053858, filed on Mar. 17, 2016, the entire contents of which are incorporated herein by reference.

### FIELD

The embodiments discussed herein are directed to an information processing apparatus, an information processing system, a non-transitory computer-readable recording medium having stored therein a program, and a method for processing information.

### BACKGROUND

In the event of a failure of a virtual host device in an information processing system of the virtualized environment, a countermeasure called migration that migrates a virtual machine to another normal virtual host device will be taken for continuing the operation.

Migration may sometimes occur not in response to an instruction from a management server. In such a case, software that manages the configuration of the virtualized environment detects the occurring migration; determines the virtual machine after the migration to be the same as one before the migration; and continues the management of the configuration of the environment.

Migration of a virtual machine in a local network (e.g., in a “company”) is accomplished by, for example, copying a virtual machine image (also referred to as an “image disk”) between the same type of virtual host devices. In this case, the virtual machine after the migration is determined to be the same as one before the migration in, for example, any of the following methods.

(1) The determination is based on the Media Access Control (MAC) address of a network port of each virtual machine.

(2) The determination is based on an identifier univocally allocated to each virtual machine by the virtual host device.

(3) The determination is based on an identifier univocally installed into each virtual machine by an agent.
[Patent Literature 1] International Publication Pamphlet No. WO2015/092847
[Patent Literature 2] Japanese Laid-open Patent Publication No. 2011-210151

In accordance with forthcoming widespread of multicloud, migration is expected to be carried out between a local network and a public cloud and between public clouds in addition to within a local network. This means that various types of virtual host devices appear and another way of migration that generates a new virtual machine of the migration destination from the generating definition of the source virtual machine would appear in addition to a traditional way of copying a virtual machine image.

Providing identifiers to determine whether virtual machines are the same in each individual cloud has a risk of making the above traditional way impossible to determine whether virtual machines are the same.

### SUMMARY

According to an aspect of the embodiments, an information processing apparatus includes a first determiner that determines, when a second virtual machine of a migration destination is generated from a first virtual machine of a migration source, whether a first generating definition representing a specification of the first virtual machine matches a second generating definition representing a specification of the second virtual machine, a second determiner that determines whether first version information representing a version of software having been installed in the first virtual machine matches second version information representing a version of software having been installed in the second virtual machine, and a third determiner that determines, when the first determiner determines that the first generating definition matches the second generating definition and the second determiner determines that the first version information matches the second version information, the second virtual machine has the same configuration as the first virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating an example of the hardware configuration of an information processing system according to a first embodiment;

FIG. 2 is a diagram illustrating a first example of migration of related art;

FIG. 3 is a flow diagram illustrating procedural steps of a first example of migration of related art;

FIG. 4 is a diagram illustrating a second example of migration of related art;

FIG. 5 is a diagram schematically illustrating an example of the software configuration of an information processing system according to the first embodiment;

FIG. 6 is a diagram illustrating an example of a manner of generating a verifying definition of an information processing system of the first embodiment;

FIG. 7 is a diagram illustrating an example of a server configuration database (DB) in an information processing system of the first embodiment;

FIG. 8 is a flow diagram illustrating an example of a succession of procedural steps of migration in an information processing system of the first embodiment;

FIG. 9 is a flow diagram illustrating a succession of procedural steps of determination of a virtual machine in an information processing system of the first embodiment;

FIG. 10 is a flow diagram illustrating a succession of procedural steps of generating a verifying definition of an information processing system of the first embodiment;

FIG. 11 is a diagram schematically illustrating an example of the hardware configuration of an information processing system of a second embodiment;

FIG. 12 is a diagram schematically illustrating an example of the software configuration of an information processing system of the second embodiment;

FIG. 13 is a diagram illustrating an example of a server configuration DB in an information processing system of the second embodiment;

FIG. 14 is a flow diagram illustrating a scale out of an information processing system of the second embodiment; and

FIG. 15 is a flow diagram illustrating a succession of procedural steps of determination of a virtual machine of an information processing system of the second embodiment.

### DESCRIPTION OF EMBODIMENT(S)

Hereinafter, embodiments will now be described with reference to the accompanying drawings. The following embodiments are exemplary and have no intention to exclude various modifications and applications of techniques not referred in embodiments. In other words, various changes and modifications can be suggested without departing from the spirit of the first embodiment.

The drawings do not illustrate therein all the functions and elements included in the embodiment and may include additional functions and elements to those illustrated in the accompanying drawings.

In the drawings, the same reference number represents the same or similar element or part, so repetitious description will be omitted.

### (A) First Embodiment

(A-1) System Configuration:

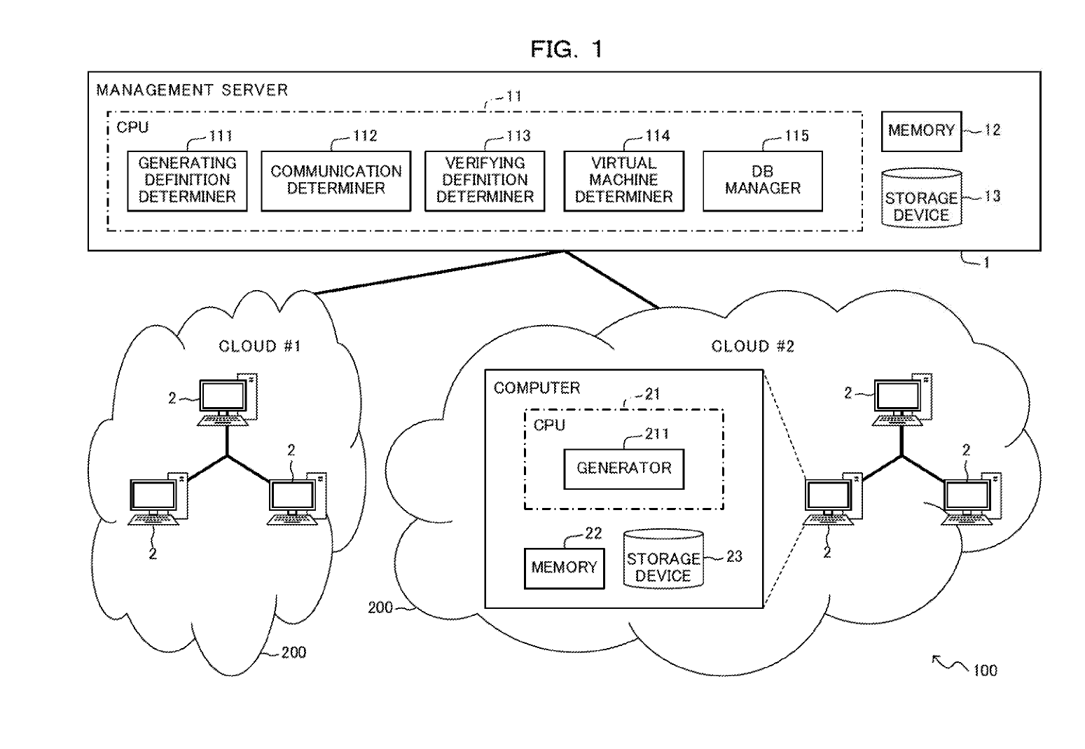

FIG. 1 is a diagram schematically illustrating an example of the configuration of an information processing system 100 according to an example of the first embodiment.

As illustrated in FIG. 1, the information processing system 100 includes a management server 1 and multiple (six in the illustrated example) computers 2. The management server 1 and the multiple computers 2 are communicably connected with one another.

The multiple computers 2 are disposed on clouds 200 (a cloud #1 and a cloud #2). In the example of FIG. 1, three computers 2 are provided for each of the clouds #1 and #2.

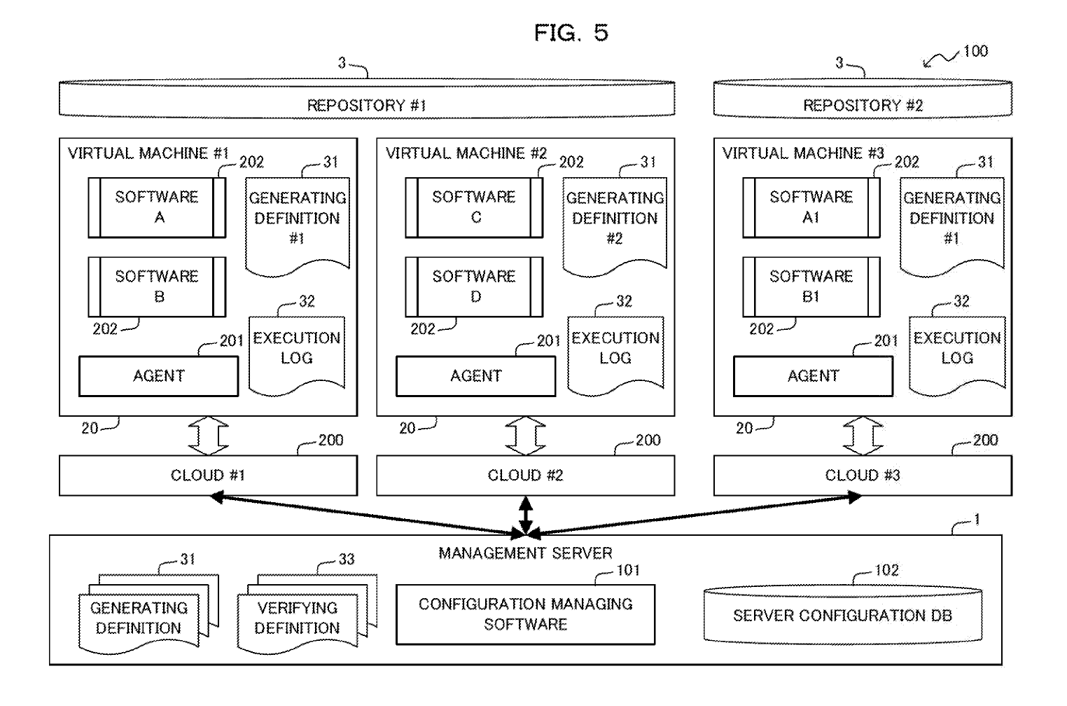

The information processing system 100 carries out migration of a virtual machine 20 (to be detailed below with reference to, for example, FIG. 5) expanded in a computer 2 between multiple clouds 200. For example, the information processing system 100 generates, in a computer 2 disposed in the cloud #2, a virtual machine 20 having the same configuration as a virtual machine 20 expanded in a computer 2 disposed in the cloud #1.

Each computer 2 includes a Central Processing Unit (CPU) 21, a memory 22, and a storage device 23. In FIG. 1, the hardware configuration of only one computer 2 appears.

The storage device 23 is a device that readably and writably stores data and may be a Hard Disk Drive (HDD), a Solid State Drive (SSD), or a Storage Class Memory (SCM).

The memory 22 is a storage device including a Read Only Memory (ROM) and a Random Access Memory (RAM). In the ROM of the memory 22, a program such as Basic Input/output System (BIOS) may be written. The software program stored in the memory 22 may be occasionally read and executed by the CPU 21. The RAM of the memory 22 may be used as a primary recording memory or a working memory.

The CPU 21 is a processor that carries out various controls and calculations, and achieves various functions by executing the Operating System (OS) and a program stored in the memory 22. As illustrated in FIG. 1, the CPU 21 may function as a generator 211.

The program to achieve the function of the generator 211 may be provided in the form of being stored in a computer-readable recording medium such as a flexible disk, a CD (e.g., CD-ROM, CD-R, and CD-RW), a DVD (e.g., DVD-ROM, DVD-RAM, DVD-R, DVD+R, DVD-RW, DVD+RW, and HD DVD), a Blu-ray disk, a magnetic disk, an optical disk, and a magneto-optical disk. The computer (in this embodiment, the CPU 21) reads a program from the above medium through a non-illustrated reader device and forwards and stores the program to and in an internal or external recording device for future use. Alternatively, a program may be stored in a storage device (recording medium), such as a magnetic disk, an optical disk, a magneto-optical disk, and provided to a computer from the storage device through a communication path.

In achieving the functions as the generator 211, a computer (in this embodiment, the CPU 21) may execute the program stored in an internal storage device (in this embodiment, the memory 22). Alternatively, the program recorded in a recording medium may be read and executed by the computer.

The generator 211 carries out migration of a virtual machine 20 (to be detailed below with reference to, for example, FIG. 5). Specifically, the generator 211 generates a virtual machine 20 in the computer 2 of the migration destination from a virtual machine 20 expanded in the computer 2 of the migration source. The generator 211 may generate a virtual machine 20 of the migration destination using a generating definition 31 (to be detailed below with reference to, for example, FIG. 5) having been used for generating the virtual machine 20 of the migration source.

The generator 211 may notify the management server 1 of the Hash value of the generating definition 31 having been used for generating the virtual machine of the migration source.

The management server 1 includes a CPU 11, a memory 12, and a storage device 13.

The storage device 13 is a device that readably and writably stores data and may be an HDD, an SSD, or an SCM.

The memory 12 is a storage device including a ROM and a RAM. In the ROM of the memory 12, a program such as BIOS may be written. The software program stored in the memory 12 may be occasionally read and executed by the CPU 11. The RAM of the memory 12 may be used as a primary recording memory or a working memory.

The CPU 11 is a processor that carries out various controls and calculations, and achieves various functions by executing the OS and a program stored in the memory 12. As illustrated in FIG. 1, the CPU 11 may function as a generating definition determiner 111, a communication determiner 112, a verifying definition determiner 113, a virtual machine determiner 114, and a database (DB) manager 115.

The program to achieve the generating definition determiner 111, the communication determiner 112, the verifying definition determiner 113, the virtual machine determiner 114, and the DB manager 115 may be provided in the form of being stored in a computer-readable recording medium such as a flexible disk, a CD (e.g., CD-ROM, CD-R, and CD-RW), a DVD (e.g., DVD-ROM, DVD-RAM, DVD-R, DVD+R, DVD-RW, DVD+RW, and HD DVD), a Blu-ray disk, a magnetic disk, an optical disk, and a magneto-optical disk. The computer (in this embodiment, the CPU 11) reads a program from the above medium through a non-illustrated reader device and forwards and stores the program to and in an internal or external recording device for future use. Alternatively, a program may be stored in a storage device (recording medium), such as a magnetic disk, an optical disk, a magneto-optical disk, and provided to a computer from the storage device through a communication path.

In achieving the functions as the generating definition determiner 111, the communication determiner 112, the verifying definition determiner 113, the virtual machine determiner 114, and the DB manager 115, a computer (in this embodiment, the CPU 11) may execute the program stored in an internal storage device (in this embodiment, the memory 12). Alternatively, the program recorded in a recording medium may be read and executed by the computer.

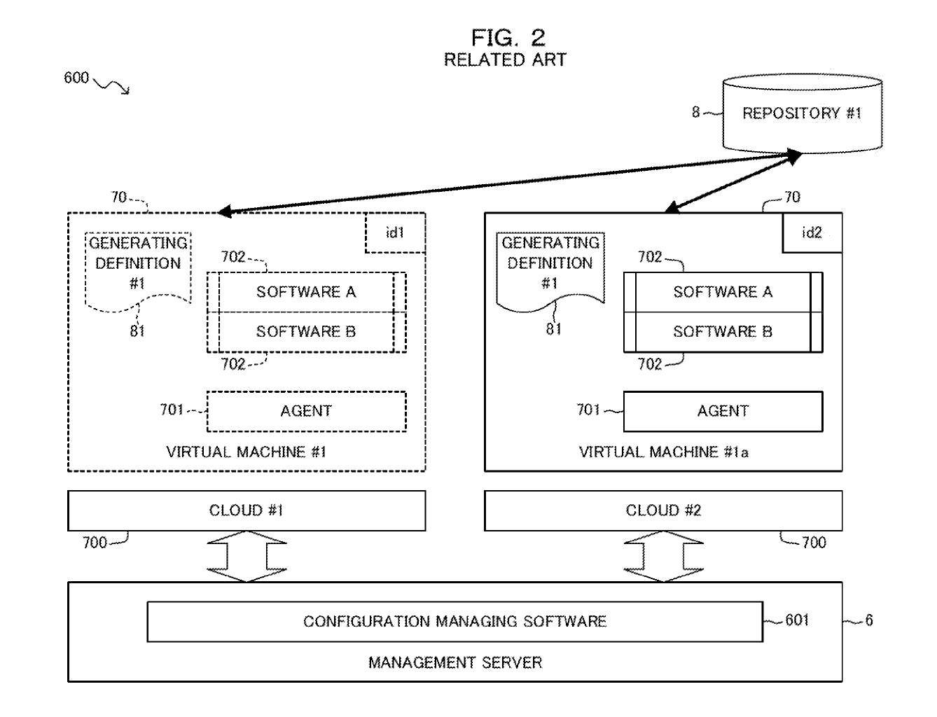

Before the description of the functions of the generating definition determiner 111, the communication determiner 112, the verifying definition determiner 113, the virtual machine determiner 114, and the DB manager 115, information processing systems 600 and 600a of related art will now be described with reference to FIGS. 2-4.

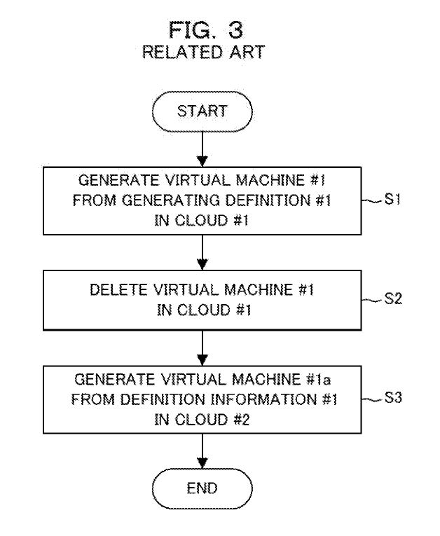

FIG. 2 is a diagram illustrating a first example of migration of related art and FIG. 3 is a flow diagram denoting a succession of procedural steps of the migration performed in the first example of the migration of the related art.

As illustrated in FIG. 2, the information processing system 600 of related art includes a management server 6, computers (not illustrated in FIG. 2), and a repository 8.

The computers are disposed in multiple clouds 700 (clouds #1 and #2) and expand virtual machines 70 (virtual machines #1 and #2) in the clouds 700. In the example of FIG. 2, a virtual machine #1 is expanded in the computer on the cloud #1 and a virtual machine #1a is expanded in the computer on the cloud #2.

The management server 6 includes configuration managing software 601, which issues an instruction related to migration to the virtual machines 70.

Each virtual machine 70 includes an agent 701, software 702, and a generating definition 81.

In the example of FIG. 2, the virtual machine #1 includes software A and software B, as the software 702, and a generating definition #1 as the generating definition 81.

The agent 701 generates a virtual machine 70 of a migration destination from a virtual machine of the migration source.

The repository 8 (repository #1) is accessible from the virtual machines #1 and #2, and stores the software 702.

Here, description will now be made in relation to a process (steps S1-S3) of migrating the virtual machine #1 on the cloud #1, as the virtual machine #1a, onto the cloud #2 along the flow diagram FIG. 3 with reference to FIG. 2.

The agent 701 of the virtual machine #1 generates a virtual machine #1 from the generating definition #1 in the cloud #1 (step S1). The agent 701 of the virtual machine #1 may generate the virtual machine #1 by downloading software 702 from the repository #1 on the basis of a software name defined in the generating definition #1.

In the migration of the virtual machine #1 in the cloud #1, as the cloud #1a, to the cloud #2, the agent 701 of the virtual machine #1 deletes the virtual machine #1 in the cloud #1 (step S2).

In the cloud #2, the agent 701 of the virtual machine #1a generates the virtual machine #1a from the generating definition #1 (step S3). The agent 701 of the virtual machine #1a may generate the virtual machine #1a by downloading software 702 from the repository #1 on the basis of a software name defined in the generating definition #1. After that, the process ends.

After the migration is completed, the configuration managing software 601 determines whether the virtual machine #1a of the migration destination is a virtual machine 70 having the same configuration as that of the virtual machine #1 of the migration source.

Each virtual machine 70 is provided an identifier peculiar to each cloud 700. In the example of FIG. 2, an identifier “id1” is provided to the virtual machine #1 and an identifier “id2” is provided to the virtual machine #1a.

In migration of a virtual machine in a local network, an identifier unique to each virtual machine is adopted, so that the virtual machine after the migration can be referred by the same identifier adopted to the virtual machine before the migration.

In contrast to the above, the information processing system 600 under a multicloud environment illustrated in FIG. 2 regenerates a virtual machine 70 in the another 700 from the generating definition 81. This adopts an identifier different with each 700, which makes the configuration managing software 601 impossible to determine the virtual machines #1 and #1a are virtual machines 70 having the same configuration.

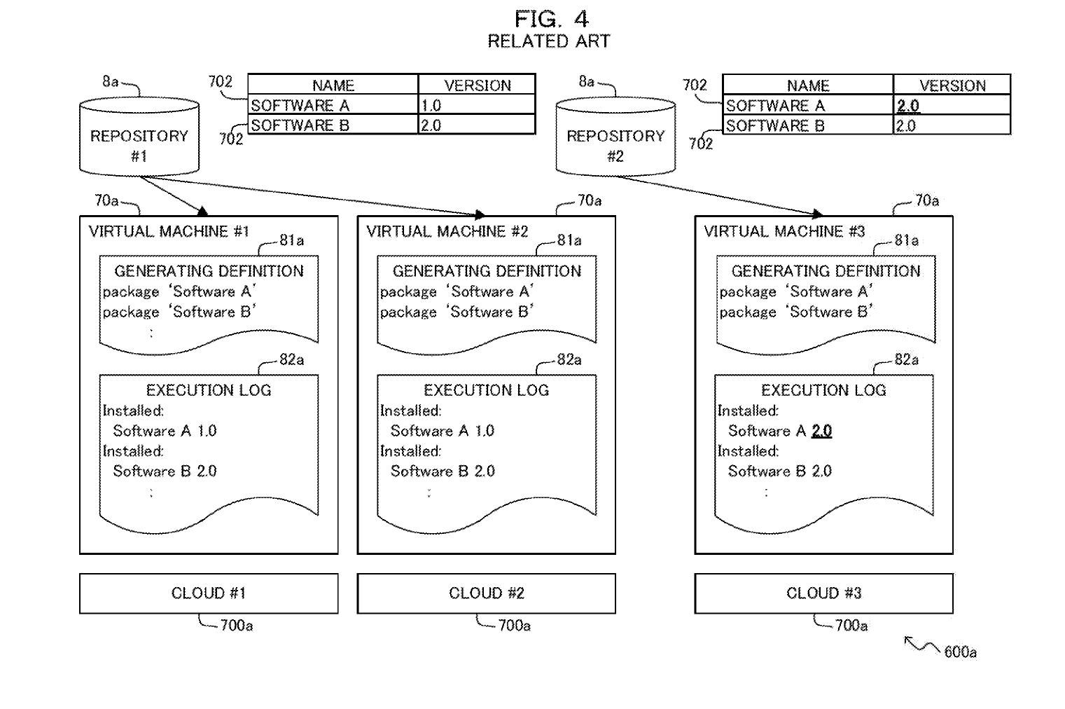

FIG. 4 is a diagram illustrating the second example of migration of related art.

As illustrated in FIG. 4, the information processing system 600a of related art includes a management server (not illustrated in FIG. 4), computers (not illustrated in FIG. 4), and a repository 8a.

The computers are disposed in multiple clouds 700a (clouds #1-#3) and expand virtual machines 70a (virtual machines #1-#3) in the clouds 700a. In the example of FIG. 4, a virtual machine #1 is expanded in the computer on the cloud #1; a virtual machine #2 is expanded in the computer on the cloud #2; and a virtual machine #3 is expanded in the computer on the cloud #3.

Each virtual machine 70a includes an agent (not illustrated in FIG. 4), software 702, a generating definition 81a, and an execution log 82a.

As illustrated in the generating definition 81a of the example of FIG. 4, the virtual machine #1 includes “Software A” and “Software B” as the software 702. As understood from the execution log 82a, the versions of the “Software A” and the “Software B” in the virtual machine #1 are “1.0” and “2.0”, respectively, in the virtual machine #1.

The repository 8a is accessible from a virtual machine 70a, and stores the software 702.

Specifically, the repository #1 is accessible from the virtual machines #1 and #2 and stores the “Software A” of “version 1.0” and the “Software B” of “version 2.0”. The repository #2 is accessible from the virtual machine #3 and stores the “Software A” of “version 2.0” and the “Software B” of “version 2.0”.

With reference to FIG. 4, description will be made in relation to an example that the virtual machine #1 on the cloud #1 is to be migrated to the virtual machine #2 on the cloud #2 and the virtual machine #3 on the cloud #3.

The agent (not illustrated in FIG. 4) of the virtual machine #2 generates a virtual machine #2 from the generating definition 81a in the cloud #2. The agent of the virtual machine #2 may generate the virtual machine #2 by downloading the software 702 from the repository #1 on the basis of a software name defined in the generating definition 81a.

The agent (not illustrated in FIG. 4) of the virtual machine #3 generates a virtual machine #3 from the generating definition 81a in the cloud #3. The agent of the virtual machine #3 may generate the virtual machine #3 by downloading the software 702 from the repository #2 on the basis of a software name defined in the generating definition 81a.

Into the virtual machine #2, the “Software A” of “version 1.0” and the “Software B” of “version 2.0” stored in the repository #1 are installed as illustrated in the generating definition 81a and the execution log 82a. In contrast, into the virtual machine #3, the “Software A” of “version 2.0” and the “Software B” of “version 2.0” stored in the repository #2 are installed as illustrated in the generating definition 81a and the execution log 82a.

In the example of FIG. 4, the generating definition 81a of the virtual machine #1 matches the generating definition 81a of the virtual machine #2 and the execution log 82a of the virtual machine #1 matches that of the virtual machine #2. On the other hand, although the generating definition 81a of the virtual machine #1 matches that of the virtual machine #3, the execution log 82a of the virtual machine #1 is different from that of the virtual machine #3. Specifically, the version of the “Software A” is “1.0” in the execution log 82a of the virtual machine #1 connected to the repository #1 while the version of the “Software A” is “2.0” in the execution log 82a of the virtual machine #3 connected to the repository #2.

Since the clouds 700a refer to different repositories 8a, virtual machines 70a even generated from the same generating definition 81a have possibility of not being installed software 702 of the same version. For this reason, if making determination only on the basis of whether the generating definition 81 of a virtual machine matches that of another virtual machine, the configuration managing software 601 (not illustrated in FIG. 4) of the management server determines that different virtual machines 70a have the same configuration as each other.

The information processing system 100 according to an example of the first embodiment has the hardware configuration of FIG. 1 and the software configuration of FIG. 5 so that determination as to whether virtual machines 20 have the same configuration is appropriately made when a virtual machine 20 is migrated between different networks.

FIG. 5 is a diagram schematically illustrating the software configuration of the information processing system 100 of the first embodiment.

The computers 2 (not illustrated in FIG. 5) are disposed in multiple clouds 200 (clouds #1-#3) and expand virtual machines 20a (virtual machines #1-#3) in the clouds 200. In the example of FIG. 5, a virtual machine #1 is expanded in the computer 2 on the cloud #1; a virtual machine #2 is expanded in the computer 2 on the cloud #2; and a virtual machine #3 is expanded in the computer 2 on the cloud #3.

The management server 1 includes configuration managing software 101, a server configuration DB 102, a generating definition 31, and a verifying definition 33.

The configuration managing software 101 issues an instruction related to migration to a virtual machine 20.

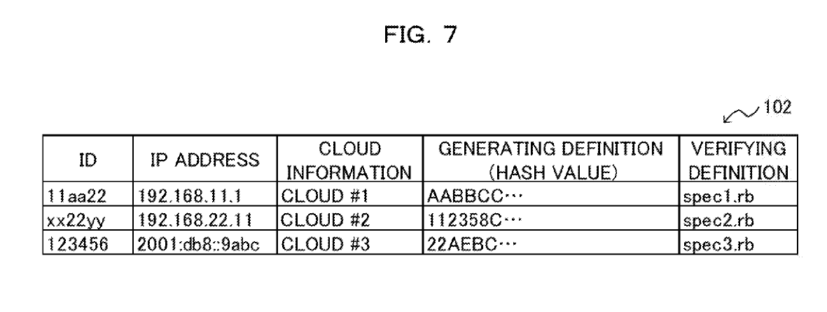

The server configuration DB 102 includes information about a virtual machine 20 generated in the information processing system 100. The server configuration DB 102 may be stored in, for example, the storage device 13 illustrated in FIG. 1. The server configuration DB 102 will be detailed below with reference to FIG. 7.

The generating definition 31 indicates the specification of a virtual machine 20 generated in the information processing system 100. The generating definition 31 may be stored in, for example, the storage device 13 included in the management server illustrated in FIG. 1.

The generating definition 31 may be any of the following items (1)-(3).

(1) recipe of Chef/Itamae

(2) Playbook of Ansible

(3) Heat Orchestration Template (HOT) of OpenStack Heat

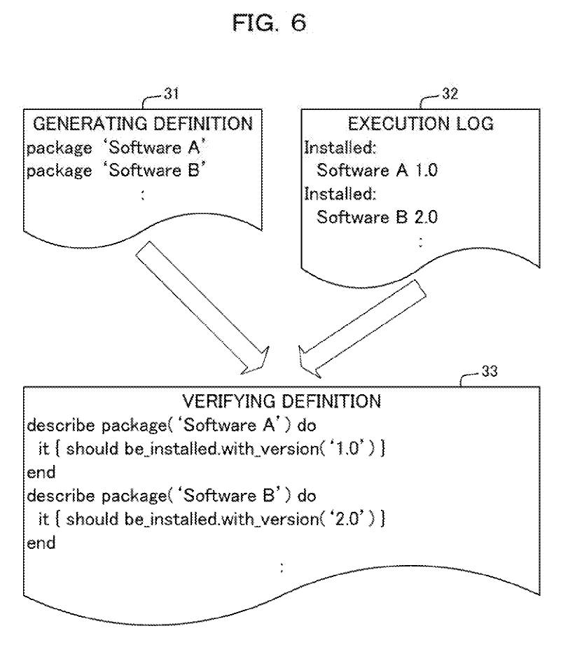

The verifying definition 33 is a program to verify that a virtual machine 20 has been correctly generated, and contains information representing the version of the software having been installed into the generated virtual machine 20. An example of the verifying definition 33 includes Serverspec. The verifying definition 33 may be stored in the storage device 13 illustrated in FIG. 1. The method of generating the verifying definition 33 will be detailed below with reference to FIG. 6.

A virtual machine 20 includes an agent 201, software 202, a generating definition 31, and an execution log 32.

In the example of FIG. 5, the virtual machine #1 includes software A and software B, as the software 202, and a generating definition #1 as the generating definition 31. The virtual machine #2 includes software C and software D, as the software 202, and a generating definition #2 as the generating definition 31. The virtual machine #3 includes software A1 and software B1, as the software 202, and a generating definition #1 as the generating definition 31.

The generating definition 31 may be stored in, for example, the storage device 23 of the computer illustrated in FIG. 1.

The execution log 32 is an execution log when the virtual machine 20 is generated. The execution log 32 may be stored in, for example, the storage device of the computer 2 illustrated in FIG. 1. The execution log 32 will be detailed below with reference to FIG. 6.

The agent 201 corresponds to the generator 211 included in the computer 2 illustrated in FIG. 1, and carries out migration of the virtual machine 20. In the example of FIG. 5, the agent 201 generates the virtual machine #3 of the migration destination from the virtual machine #1 of the migration source on the basis of the generating definition #1.

The repository 3 is accessible from a virtual machine 20, and stores the software 202. Specifically, the repository #1 is accessible from the virtual machines #1 and #2 and stores software A-D. The repository #2 is accessible from the virtual machine #3 and stores software A1 and B1.

Hereinafter, description will now be made in relation to the generating definition determiner 111, the communication determiner 112, the verifying definition determiner 113, the virtual machine determiner 114, and the DB manager 115 of the CPU 11 included in the management server 1 illustrated in FIG. 1.

The generating definition determiner 111 is an example of the first determiner and determines whether the respective generating definitions 31 used for generating two virtual machines 20 match. Specifically, when the virtual machine 20 of the migration destination is generated by the generator 211, the generating definition determiner 111 may determine whether the respective generating definitions 31 used for generating the two virtual machines 20 match.

In other words, when a second virtual machine 20 is generated on the basis of a first virtual machine 20, the generating definition determiner 111 determines whether a first generating definition 31 representing the specification of the first virtual machine 20 matches a second generating definition 31 representing the specification of the second virtual machine 20.

In the example of FIG. 5, the generating definition determiner 111 determines, when the virtual machine #3 of the migration destination has been generated, whether the generating definition #1 used for generating the virtual machine #1 matches the generating definition #1 used for generating the virtual machine #3.

For this purpose, the generating definition determiner 111 may obtain the Hash value of the generating definition 31 from the virtual machine 20 of the migration destination. Then the generating definition determiner 111 may extract the Hash value of a generating definition 31 the same as the Hash value obtained from the generating definition 31 from the server configuration DB 102.

The communication determiner 112 is an example of a fourth determiner and determines whether the management server 1 is communicable with the virtual machine 20 of the migration source.

In the example of FIG. 5, the communication determiner 112 determines whether the management server 1 is communicable with the virtual machine #1 of the migration source.

The verifying definition determiner 113 is an example of a second determiner and causes a virtual machine 20 of the migration destination to execute a verifying definition 33 including information related to the version of the software 202 having been installed in the virtual machine 20 of the migration source. Specifically, the verifying definition determiner 113 causes the virtual machine 20 of the migration destination to execute the verifying definition 33 generated on the basis of the generating definition 31 and the execution log 32 of the virtual machine 20 of the migration source. After that, the verifying definition determiner 113 determines whether the verifying definition 33 has been correctly executed in the virtual machine 20 of the migration destination.

This makes it possible to efficiently determine whether the version of the software 202 having been installed in the virtual machine 20 of the migration destination matches the version of the software 202 having been installed in the virtual machine 20 of the destination source.

In other words, the verifying definition determiner 113 determines whether first version information matches second version information. The first version information represents the version of the software 202 having been installed in the virtual machine 20 of the migration source. The second version information represents the version of the software 202 having been installed in the virtual machine 20 of the migration destination.

In the example of FIG. 5, the verifying definition determiner 113 causes the virtual machine #3 to execute the verifying definition 33 generated on the basis of the generating definition #1 and the execution log 32 of the virtual machine #1. Then, the verifying definition determiner 113 determines whether the verifying definition 33 has been correctly executed in the virtual machine #3.

Specifically, in the example of FIG. 5, the verifying definition determiner 113 determines whether the respective versions of the software A and B of the virtual machine #1 match the versions of the software A1 and B1 of the virtual machine #3, respectively.

The virtual machine determiner 114 is an example of a third determiner, and determines whether the virtual machine 20 of the migration destination has the same configuration as the virtual machine 20 of the migration source.

Specifically, when the generating definition determiner 111 determines that the generating definitions 31 of two virtual machines 20 match and the verifying definition determiner 113 determines that the version information of the respective virtual machines 20 matches, the virtual machine determiner 114 determines that the two virtual machines 20 have the same configuration.

The case where the generating definition determiner 111 determines that the generating definitions 31 match corresponds to a case where the generating definition 31 used for generating the virtual machine 20 of the migration destination matches with that used for generating the virtual machine 20 of the migration source. The case where the verifying definition determiner 113 determines that the respective version information match corresponds to a case where the first version information related to the virtual machine 20 of the migration destination matches the second version information related to the virtual machine 20 of the migration source.

With this configuration, determination as to whether virtual machines 20 have the same configuration is appropriately made when a virtual machine 20 is migrated between different networks.

In the example of FIG. 5, the virtual machine determiner 114 determines whether the generating definitions #1 of the virtual machines #1 and #3 match and also whether the versions of the software A and B of the virtual machine #1 match the versions of the software A1 and B1 of the virtual machine #3, respectively. When the generating definition 31 and the version of the software 202 of the virtual machine #1 match those of the virtual machine #3, the virtual machine determiner 114 determines that the virtual machine #3 has the same configuration as the virtual machine #1.

In addition to the result of the determination made by the generating definition determiner 111 and the verifying definition determiner 113, the virtual machine determiner 114 may determine whether the two virtual machines 20 have the same configuration on the basis of the result of determination made by the communication determiner 112. Specifically, in addition to the result of the determination made by the generating definition determiner 111 and the verifying definition determiner 113, the virtual machine determiner 114 may determine that the two virtual machines 20 have the same configuration when the management server 1 is determined not to be communicable with the virtual machine 20 of the destination source.

Upon completion of the migration, since the virtual machine 20 of the migration source is discarded and thereby comes not to be communicable with the management server 1, determination whether the management server 1 is communicable with the virtual machine 20 of the migration source makes it possible to appropriately determine whether the virtual machine of the migration destination is the same as the virtual machine 20 of the migration source.

In the example of FIG. 5, in addition to the result of the determination made by the generating definition determiner 111 and the verifying definition determiner 113, the virtual machine determiner 114 may determine whether the virtual machine #1 has the same configuration as the virtual machine #3 when the management server 1 is determined not to be communicable with the virtual machine #1 of the destination source.

The DB manager 115 updates the server configuration DB 102 on the basis of the result of the determination made by the virtual machine determiner 114.

Specifically, when the virtual machine 20 of the migration destination is determined to have the same configuration with the virtual machine 20 of the migration source, the DB manager 115 overwrites information related to the virtual machine 20 of the migration source with information related to the virtual machine 20 of the migration destination in the server configuration DB 102.

In contrast, when the virtual machine 20 of the migration destination is determined not to have the same configuration with the virtual machine 20 of the migration source, the DB manager 115 adds information related to the virtual machine 20 of the migration destination to the server configuration DB 102.

FIG. 6 is a diagram illustrating an example of a manner of generating a verifying definition 33 of the information processing system 100 of the first embodiment.

As illustrated in FIG. 6, the verifying definition 33 is generated on the basis of the generating definition 31 and is specifically generated by incorporating information (i.e., “version information”) related to an execution log 32 into the generated generating definition 31. The verifying definition 33 may be generated by, for example, the CPU 11 (in other words, the configuration managing software 101) of the management server 1.

FIG. 7 is a diagram illustrating an example of the server configuration DB 102 of the information processing system 100 of the first embodiment.

The server configuration DB 102 contains an ID, an Internet Protocol (IP) address, cloud information, a generating definition (Hash value), and a verifying definition.

An ID represents the identifier of a virtual machine 20.

An IP address is the IP address of a virtual machine 20.

Cloud information is information that specifies a cloud 200 that the computer 2 in which the virtual machine 20 is expanded belongs to.

A generating definition (Hash value) is the Hash value of the generating definition 31 having been used for generating the virtual machine 20.

The verifying definition is the verifying definition 33 to be used for verifying the virtual machine 20.

The server configuration DB 102 of FIG. 7 denotes the configuration of the virtual machine 20 having undergone the migration over the clouds 200.

Specifically, the virtual machine #1 is represented by an ID “11aa22”, an IP address “192.168.11.1”, cloud information “cloud #1”, a Hash value “AABBCC . . . ” of the generating definition, and a verifying definition “spec1.rb”. The virtual machine #2 is represented by an ID “xx22yy”, an IP address “192.168.22.11”, cloud information “cloud #2”, a Hash value “112358C . . . ” of the generating definition, and a verifying definition “spec2.rb”. The virtual machine #3 is represented by an ID “123456”, an IP address “2001:db8::9abc”, cloud information “cloud #3”, a Hash value “22AEBC . . . ” of the generating definition, and a verifying definition “spec3.rb”.

As the above, the server configuration DB 102 after the migration over the clouds 200 have information different with each virtual machine 20.

(A-2) operation:

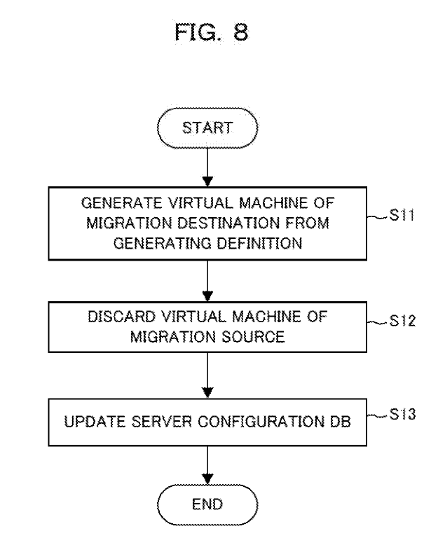

Here, description will now be made in relation to an example of migration (steps S11-S13) performed in the information processing system 100 of the first embodiment with the flow diagram of FIG. 8.

The generator 211 of the computer 2 of the migration destination generates the virtual machine 20 of the migration destination from the generating definition 31 (step S11).

The CPU 21 of the computer 2 of the migration source discards the virtual machine 20 of the migration source (step S12).

The DB manager 115 of the management server 1 updates the server configuration DB 102 on the basis of the result of the migration (step S13), and ends the process.

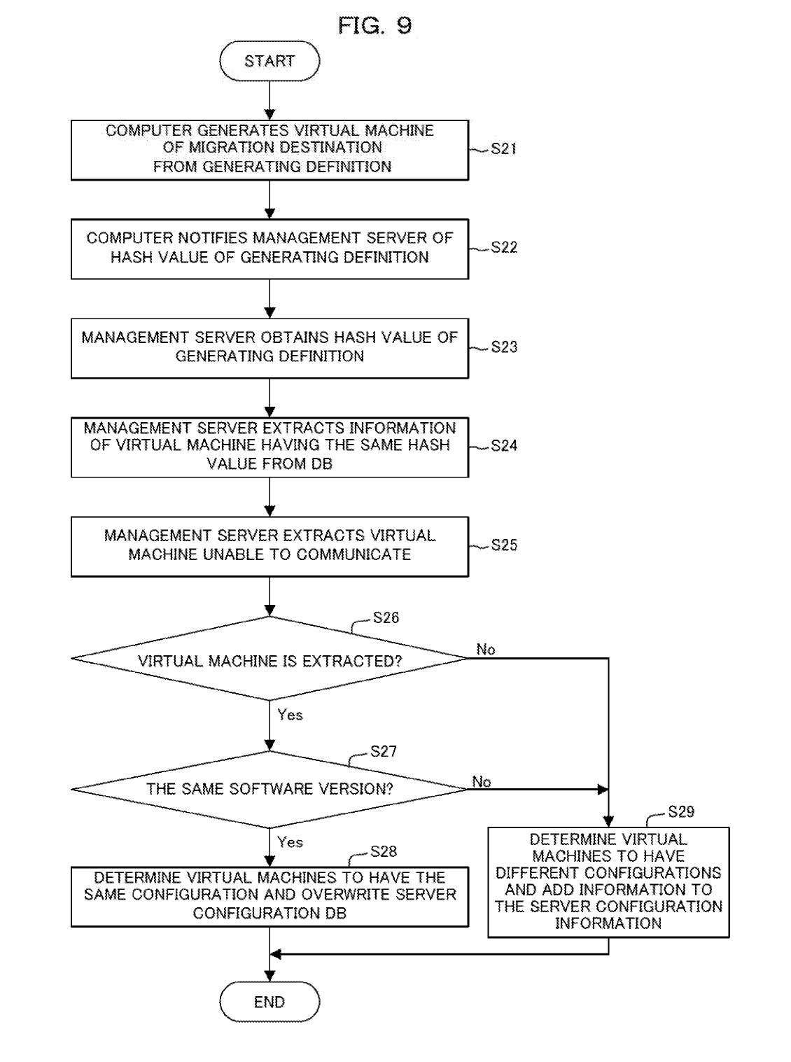

Here, description will now be made in relation to an example of determination (steps S21-S29) of a virtual machine in the information processing system 100 of the first embodiment with reference to the flow diagram of FIG. 9.

The generator 211 of the computer 2 of the migration destination generates the virtual machine 20 of the migration destination from the generating definition 31 (step S21).

The generator 211 of the computer 2 of the migration destination notifies the management server of the Hash value of the generating definition 31 (step S22).

The generating definition determiner 111 of the management server 1 obtains the Hash value of the generating definition 31 sent from the computer 2 (step S23).

The generating definition determiner 111 extracts information related to a virtual machine 20 having a Hash value of the generating definition 31 the same as the Hash value of the obtained generating definition 31 from the server configuration DB 102 (step S24).

The communication determiner 112 extracts the information related to a virtual machine 20 having an agent 201 unable to communicate with the management server 1 from the information extracted in step S24 (step S25).

The communication determiner 112 determines whether information related to a virtual machine 20 has been extracted in step S25 (step S26).

When no information related to a virtual machine 20 has been extracted in step S25 (see No route in step S26), the process moves to step S29.

In contrast, when information related to a virtual machine 20 is extracted in step S25 (see Yes route in step S26), the verifying definition determiner 113 executes the verifying definition 33 in the virtual machine 20 of the migration destination. The verifying definition determiner 113 determines whether the version of the software 202 of the virtual machine 20 of the migration source matches that of the virtual machine 20 of the migration destination from whether the verifying definition 33 has been correctly executed (step S27).

When the versions of the software 202 match (see Yes route in step S27), the virtual machine determiner 114 determines that the virtual machine of the migration destination has the same configuration as the virtual machine 20 of the migration source. Then, the DB manager 115 overwrites the information of the virtual machine 20 of the migration source with the information of the virtual machine 20 of the migration destination in the server configuration DB 102 (step S28) and ends the process.

In contrast, when the versions of the software 202 do not match (see No route in step S27), the virtual machine determiner 114 determines that the virtual machine 20 of the migration destination does not have the same configuration as the virtual machine 20 of the migration source. Then, the DB manager 115 adds the information of the virtual machine of the migration destination to the server configuration DB 102 (step S29), and ends the process.

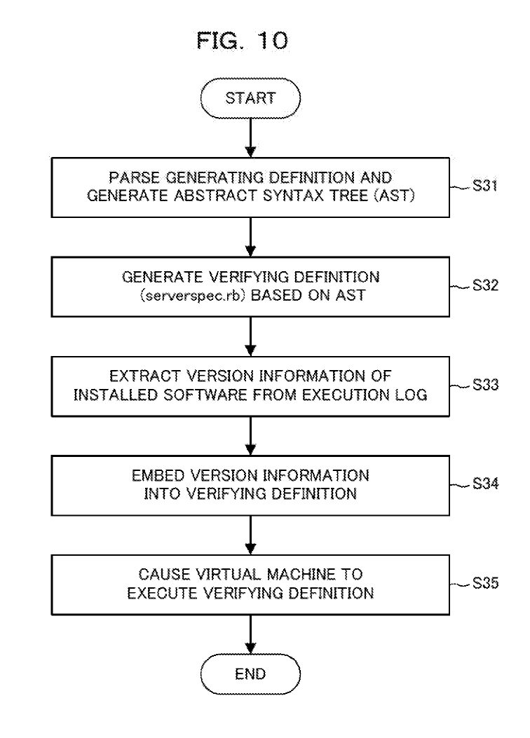

Here, description will now be made in relation to an example of generation (steps S31-S35) of a verifying definition in the information processing system 100 of the first embodiment with reference to a flow diagram of FIG. 10.

The management server 1 parses (in other words, carry out structural analysis) the generating definition 31 obtained from the virtual machine 20, and generates an Abstract Syntax Tree (AST) (step S31).

The management server 1 generates a verifying definition 33 (e.g., serverspec.rb) based on the AST generated in step S31 (step S32).

The management server 1 extracts the version information of the software 202 having been installed in a virtual machine 20 from the execution log 32 extracted from the virtual machine 20 (step S33).

The management server 1 embeds the version information extracted in step S33 into the verifying definition 33 generated in step S32 (step S34).

The management server 1 causes the virtual machine 20 of the migration destination to execute the verifying definition 33 generated in step S34 (step S35) and ends the process.

### (B) Second Embodiment

(B-1) System Configuration:

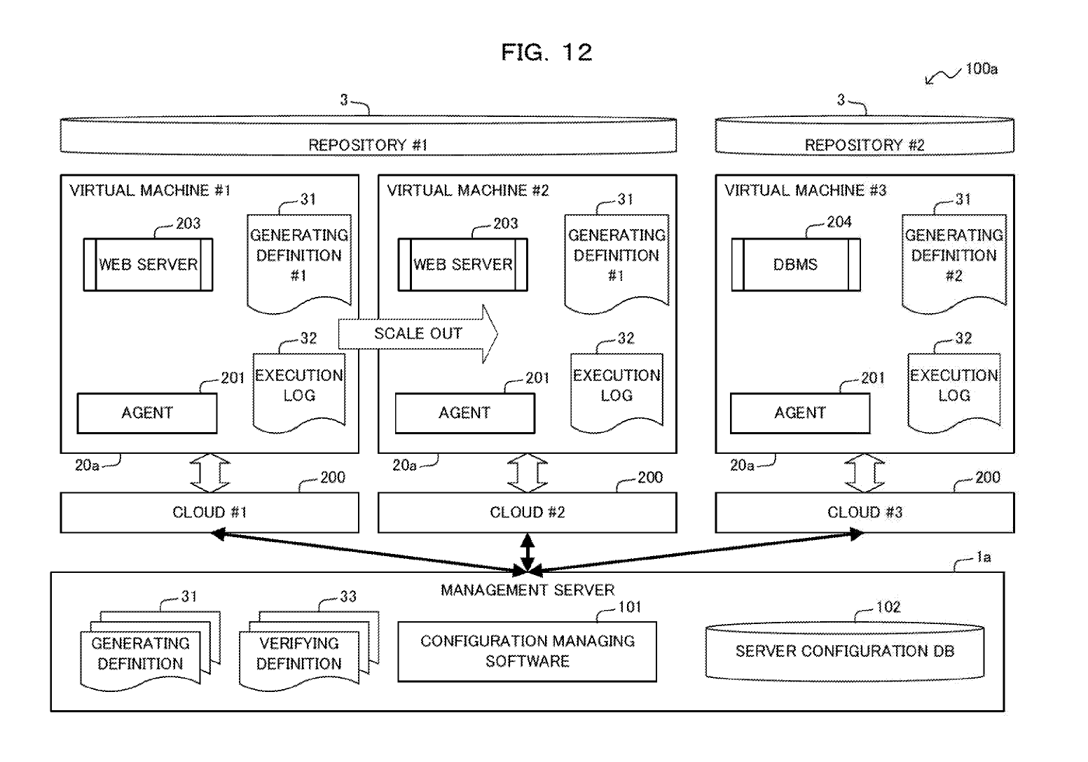

The above first embodiment determines whether the virtual machine 20 of the migration destination generated by migration is the same as the virtual machine 20 of the migration source. In contrast, the second embodiment determines whether a virtual machine 20a of the duplication destination generated by means of scale out (to be detailed below with reference to FIG. 12) is the same as one of the duplication source.

Throughout this specification, the word “scale out” means duplication of a virtual machine 20a to be used for the same purpose.

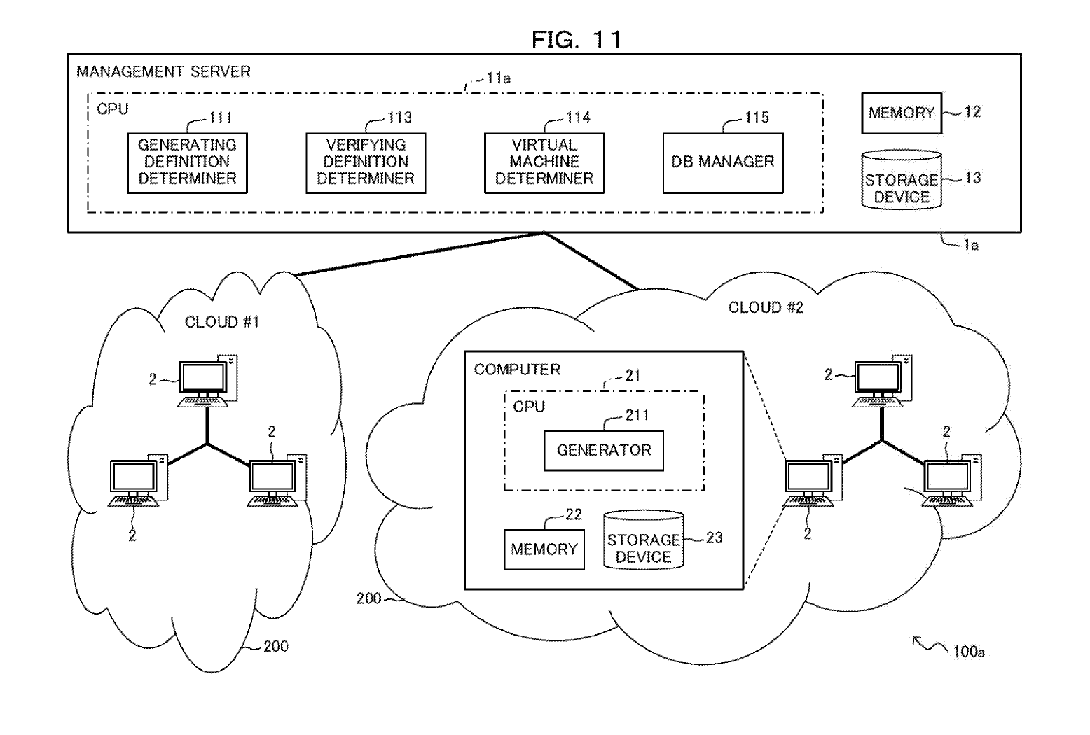

FIG. 11 is a diagram schematically illustrating an example of the hardware configuration of an information processing system 100a according to the second embodiment.

As illustrated in FIG. 11, the information processing system 100a includes a management server 1a in place of the management server 1 illustrated in FIG. 1.

As illustrated in FIG. 11, the management server 1a includes a CPU 11a in place of the CPU 11 illustrated in FIG. 1.

As illustrated in FIG. 11, the CPU 11a does not have the function of the communication determiner 112, which is included in the CPU 11 of the first embodiment illustrated in FIG. 1. In other words, the CPU 11a has the functions of the generating definition determiner 111, the verifying definition determiner 113, the virtual machine determiner 114, and the DB manager 115.

FIG. 12 is a diagram schematically illustrating an example of the software configuration of the information processing system 100a of the second embodiment.

As illustrated in FIG. 12, a computer 2 (not illustrated in FIG. 12) of the information processing system 100a expands therein a virtual machine 20a in place of the virtual machine 20 illustrated in FIG. 5. In the example of FIG. 12, a virtual machine #1 is expanded in the computer 2 on the cloud #1; a virtual machine #2 is expanded in the computer 2 on the cloud #2; and a virtual machine #3 is expanded in the computer on the cloud #3.

Likewise the management server 1 of the example of FIG. 5, the management server 1a includes configuration managing software 101, a server configuration DB 102, a generating definition 31, and a verifying definition 33.

The virtual machines 20a (virtual machines #1 and #2) each include an agent 201, software related to a Web server (hereinafter simply referred to as “Web server”) 203, a generating definition 31, and an execution log 32. The remaining virtual machine 20a (virtual machine #3) includes an agent 201, a DataBase Management System (DBMS) 204, a generating definition 31, and execution log 32.

In the example of FIG. 12, the virtual machines #1 and #2 each include a generating definition #1 as the generating definition 31. In the example of FIG. 12, the virtual machine #3 includes a generating definition #2 as the generating definition 31.

The agent 201 corresponds to the generator 211 of the computer 2 illustrated in FIG. 11 and performs scale out on a virtual machine 20a. In the example of FIG. 12, the agent 201 generates a virtual machine #2 of a duplication destination from the virtual machine #1 of the duplication source on the basis of the generating definition #1.

A repository 3 is accessible from a virtual machine 20a and stores the Web server 203 or the DBMS 204. Specifically, the repository #1 is accessible from the virtual machines #1 and #2, and stores the Web server 203. The repository #2 is accessible from the virtual machine #3 and stores the DBMS 204.

Hereinafter, description will now be made in relation to the generating definition determiner 111, the verifying definition determiner 113, the virtual machine determiner 114, and the DB manager 115 of the CPU 11 included in the management server 1a illustrated in FIG. 11.

The generating definition determiner 111 is an example of the first determiner and determines whether the respective generating definitions 31 used for generating two virtual machines 20a match. Specifically, when the virtual machine 20a of the duplication destination is generated by the generator 211, the generating definition determiner 111 may determine whether the respective generating definitions 31 used for generating the two virtual machines 20a match.

In other words, when a second virtual machine 20a is generated on the basis of a first virtual machine 20a, the generating definition determiner 111 determines whether a first generating definition 31 representing the specification of the first virtual machine 20a matches a second generating definition representing the specification of the second virtual machine 20a.

In the example of FIG. 12, the generating definition determiner 111 determines, when the virtual machine #2 of the duplication destination has been generated, whether the generating definition #1 used for generating the virtual machine #1 matches the generating definition #1 used for generating the virtual machine #2.

For this purpose, the generating definition determiner 111 may obtain the Hash value of the generating definition 31 from the virtual machine 20a of the duplication destination. Then the generating definition determiner 111 may extract the Hash value of a generating definition 31 the same as the Hash value of the obtained generating definition 31 from the server configuration DB 102.

The verifying definition determiner 113 is an example of a second determiner and causes a virtual machine 20a of the duplication destination to execute a verifying definition 33 including information related to the Web server 203 having been installed in the virtual machine 20a of the duplication source. Specifically, the verifying definition determiner 113 causes the virtual machine 20a of the duplication destination to execute the verifying definition 33 generated on the basis of the generating definition and the execution log 32 of the virtual machine 20a of the duplication source. After that, the verifying definition determiner 113 determines whether the verifying definition 33 has been correctly executed in the virtual machine 20a of the duplication destination.

This makes it possible to efficiently determine whether the version of the Web server 203 having been installed in the virtual machine 20a of the duplication destination matches the version of the Web server 203 having been installed in the virtual machine 20a of the duplication source.

In other words, the verifying definition determiner 113 determines whether first version information matches second version information. The first version information represents the version of the Web server 203 having been installed in the virtual machine 20a of the duplication source. The second version information represents the version of the Web server 203 having been installed in the virtual machine 20a of the duplication destination.

In the example of FIG. 12, the verifying definition determiner 113 causes the virtual machine #2 to execute the verifying definition 33 generated on the basis of the generating definition #1 and the execution log 32 of the virtual machine #1. Then, the verifying definition determiner 113 determines whether the verifying definition 33 has been correctly executed in the virtual machine #2.

Specifically, in the example of FIG. 12, the verifying definition determiner 113 determines whether the version of the Web server 203 of the virtual machine #1 matches the version of the Web server 203 of the virtual machine #2.

The virtual machine determiner 114 is an example of a third determiner, and determines whether the virtual machine 20a of the duplication destination has the same configuration as the virtual machine 20a of the duplication source.

Specifically, when the generating definition determiner 111 determines that the generating definitions 31 match and the verifying definition determiner 113 determines that the respective version information match, the virtual machine determiner 114 determines that the two virtual machines 20a have the same configuration.

The case where the generating definition determiner 111 determines that the generating definitions 31 match corresponds to a case where the generating definition 31 used for generating the virtual machine 20a of the duplication destination matches that used for generating the virtual machine 20a of the duplication source. The case where the verifying definition determiner 113 determines that the respective version information match corresponds to a case where the first version information related to the virtual machine 20a of the duplication source matches the second version information related to the first virtual machine 20a of the duplication destination.

With this configuration, determination as to whether virtual machines 20a have the same configuration is appropriately made when a virtual machine 20a is duplicated between different networks.

In the example of FIG. 12, the virtual machine determiner 114 determines whether the generating definitions #1 of the virtual machines #1 and #2 match and also whether the version of the Web server 203 of the virtual machine #1 match the version of the Web server 203 of the virtual machine #2. When the generating definition 31 and the version of the Web server 203 of the virtual machine #1 match those of the virtual machine #2, the virtual machine determiner 114 determines that the virtual machine #2 has the same configuration as the virtual machine #1.

The DB manager 115 updates the server configuration DB 102 on the basis of the result of the determination made by the virtual machine determiner 114.

Specifically, when the virtual machine 20a of the duplication destination is determined to have the same configuration with the virtual machine 20a of the duplication source, the DB manager 115 adds information the same as the information of the virtual machine 20a of the duplication source, as information oelated to the virtual machine 20a of the duplication destination, into the server configuration DB 102.

In contrast, when the virtual machine 20a of the duplication destination is determined not to have the same configuration with the virtual machine 20a of the duplication source, the DB manager 115 adds information related to the virtual machine 20a of the duplication destination into the server configuration DB 102.

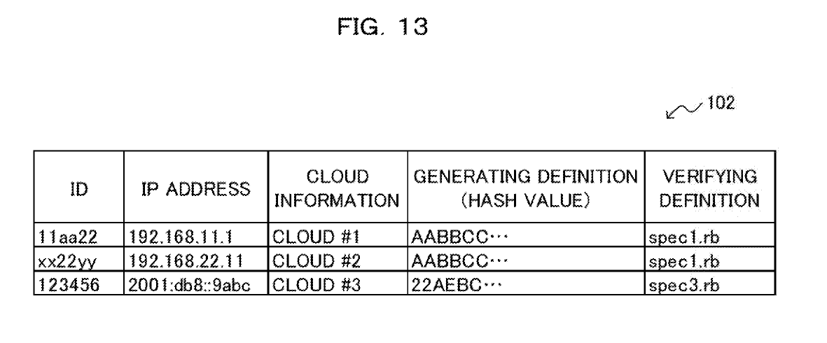

FIG. 13 is a diagram illustrating an example of the server configuration DB 102 of the information processing system 100a of the second embodiment.

The server configuration DB 102 contains an ID, an Internet Protocol (IP) address, cloud information, a generating definition (Hash value), and a verifying definition.

An ID represents the identifier of a virtual machine 20a.

An IP address is the IP address of a virtual machine 20a.

Cloud information is information that specifies a cloud 200 that the computer 2 in which the virtual machine 20a is expanded belongs to.

A generating definition (Hash value) is the Hash value of the generating definition 31 having been used for generating the virtual machine 20a.

The verifying definition is the verifying definition 33 to be used for verifying the virtual machine 20a.

The server configuration DB 102 of FIG. 13 denotes the configuration of the virtual machine 20a having undergone the scale out over the clouds 200.

Specifically, the virtual machine #1 is represented by an ID “11aa22”, an IP address “192.168.11.1”, cloud information “cloud #1”, a Hash value “AABBCC . . . ” of the generating definition, and a verifying definition “spec1.rb”. The virtual machine #2 is represented by an ID “xx22yy”, an IP address “192.168.22.11”, cloud information “cloud #2”, a Hash value “AABBCC . . . ” of the generating definition, and a verifying definition “spec1.rb”. The virtual machine #3 is represented by an ID “123456”, an IP address “2001:db8::9abc”, cloud information “cloud #3”, a Hash value “22AEBC . . . ” of the generating definition, and a verifying definition “spec3.rb”.

As the above, the server configuration DB 102 after the scale out over the clouds 200 has the Hash value of the generating definition 31 and the verifying definition of the virtual machine 20a of the duplication destination the same as those of the virtual machine 20a of the duplication source.

(B-2) Operation:

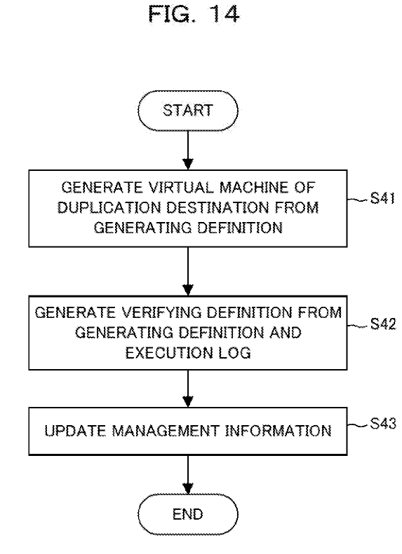

Here, description will now be made in relation to an example of scale out (steps S41-S43) performed in the information processing system 100a of the second embodiment with reference to the flow diagram of FIG. 14.

The generator 211 of the computer 2 of the duplication destination of the scale out generates a virtual machine 20a of the duplication destination from the generating definition 31 (step S41).

The CPU 11a of the management server 1a generates the verifying definition 33 based on the generating definition 31 and the execution log 32 (step S42). The step S42 is the same as a process described above with reference to the flow diagram FIG. 10.

The DB manager 115 of the management server 1a updates the server configuration DB 102 on the basis of the result of the scale out, updates the server configuration DB 102 (step S43), and ends the process.

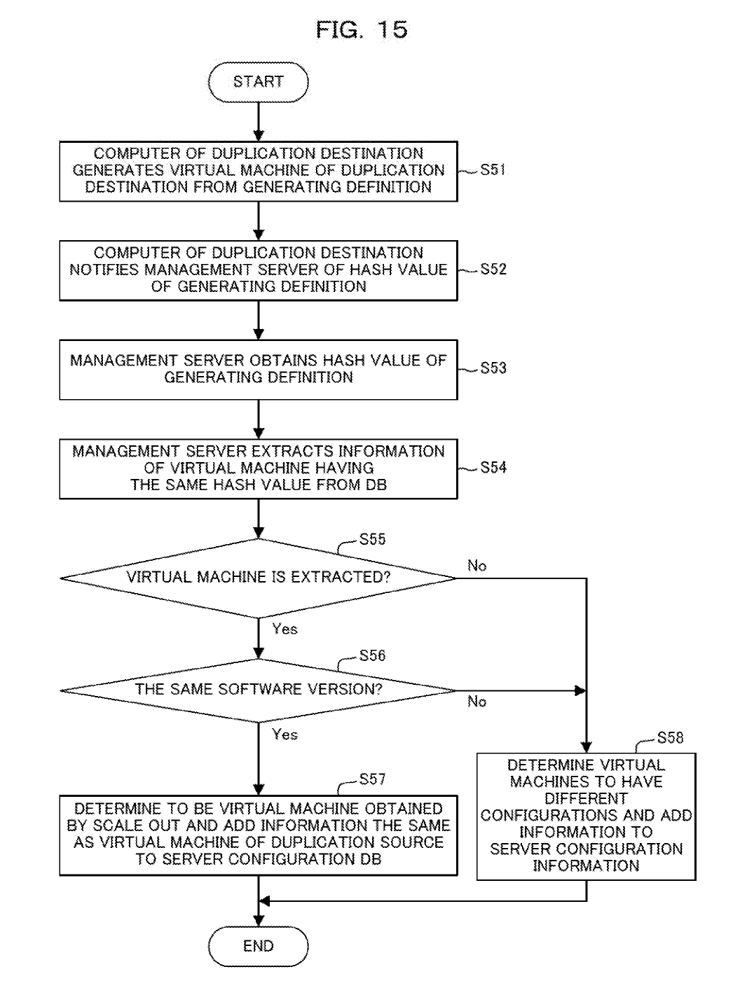

Here, description will now be made in relation to an example of determination (steps S51-S58) on a virtual machine in the information processing system 100a of the second embodiment with reference to the flow diagram of FIG. 15.

The generator 211 of the computer 2 of the duplication destination generates the virtual machine 20a of the duplication destination from the generating definition 31 (step S51).

The generator 211 of the computer 2 of the duplication destination notifies the management server 1a of the Hash value of the generating definition 31 (step S52).

The generating definition determiner 111 of the management server 1 obtains the Hash value of the generating definition 31 sent from the computer 2 (step S53).

The generating definition determiner 111 extracts information related to a virtual machine 20a having a Hash value of the generating definition 31 the same as the Hash value of the obtained generating definition 31 from the server configuration DB 102 (step S54).

The generating definition determiner 111 determines whether information related to a virtual machine 20a has been extracted in step S54 (step S55).

When no information related to a virtual machine 20a has been extracted in step S54 (see No route in step S55), the process moves to step S58.

In contrast, when information related to a virtual machine 20a is extracted in step S54 (see Yes route in step S55), the verifying definition determiner 113 executes the verifying definition 33 in the virtual machine 20a of the duplication destination. The verifying definition determiner 113 determines whether the version of the software (e.g., the “Web server 203”) of the virtual machine 20a of the duplication source matches that of the virtual machine 20a of the duplication destination by determining whether the verifying definition 33 is normally executed (step S56).

When the versions of the software match (see Yes route in step S56), the virtual machine determiner 114 determines that the virtual machine 20a of the duplication destination has been obtained as a result of the scale out. Then, the DB manager 115 adds, as the information of the virtual machine 20a of the duplication destination, information the same as the information of the virtual machine 20a of the duplication source to the server configuration DB 102 (step S57), and ends the process.

In contrast, when the versions of the software do not match (see No route in step S56), the virtual machine determiner 114 determines that the virtual machine 20a of the duplication destination does not have the same configuration as the virtual machine 20a of the duplication source. Then, the DB manager 115 adds the information of the virtual machine 20a of the duplication destination to the server configuration DB 102 (step S58), and ends the process.

The information processing system 100a of the second embodiment obtains the same effects as those obtained by the information processing system 100 of the first embodiment.

(C) Others:

The embodiments are not limited to the above descriptions. Various changes and modifications can be suggested without departing from the spirit of the embodiments. Each configuration and each process of the foregoing embodiments can appropriately be selected, omitted, or combined according to the need.

For example, the information processing system 100 of the first embodiment may determine whether a virtual machine 20a of the duplication destination of scale out is the same as a virtual machine 20a of the duplication source. This means that both the operation of the first embodiment and the operation of the second embodiment can be carries out in a single information processing system 100.

The above example of the second embodiment determines whether a virtual machine 20a of the duplication destination generated by means of scale out, which duplicates a virtual machine 20a to be used for the same purpose, is the same as a virtual machine 20a of the duplication source. However, the foregoing embodiments are not limited to this. Alternatively, the foregoing embodiments may determine whether a virtual machine 20a of the duplication destination generated by means of cloning, which duplicates a virtual machine 20 irrespective of the purpose of using the duplicate, is the same as a virtual machine 20a of the duplication source.

The information processing system disclosed herein can appropriately determine whether virtual machines migrated over different networks are the same.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a first determiner that determines, when a second virtual machine of a migration destination is generated from a first virtual machine of a migration source, whether a first generating definition representing a specification of the first virtual machine matches a second generating definition representing a specification of the second virtual machine;
a second determiner that determines whether first version information representing a version of software having been installed in the first virtual machine matches second version information representing a version of software having been installed in the second virtual machine; and
a third determiner that determines, when the first determiner determines that the first generating definition matches the second generating definition and the second determiner determines that the first version information matches the second version information, the second virtual machine has the same configuration as the first virtual machine.

2. The information processing apparatus according to claim 1, wherein:
the second determiner executes a verifying definition including the first version information on the second virtual machine to determine whether the first version information matches the second version information; and
the verifying definition is based on the first generating definition and the first version information is embedded in the verifying definition.

3. The information processing apparatus according to claim 1, further comprising a fourth determiner that determines whether the first virtual machine is communicable with the information processing apparatus, wherein
when the fourth determiner determines that the first virtual machine is not communicable with the information processing apparatus, the third determiner determines that the second virtual machine has the same configuration as the first virtual machine.

4. An information processing system comprising:
a first computer;
a second computer; and
an information processing apparatus that manages the first computer and the second computer, wherein:
the second computer comprises a generator that generates a second virtual machine of a migration destination from a first virtual machine of a migration source expanded in the first computer; and
the information processing apparatus comprises
a first determiner that determines, when the second virtual machine is generated by the generator, whether a first generating definition representing a specification of the first virtual machine matches a second generating definition representing a specification of the second virtual machine;
a second determiner that determines whether first version information representing a version of software having been installed in the first virtual machine matches second version information representing a version of software having been installed in the second virtual machine; and
a third determiner that determines, when the first determiner determines that the first generating definition matches the second generating definition and the second determiner determines that the first version information matches the second version information, the second virtual machine has the same configuration as the first virtual machine.

5. The information processing system according to claim 4, wherein:
the second determiner executes a verifying definition including the first version information on the second virtual machine to determine whether the first version information matches the second version information; and
the verifying definition is based on the first generating definition and the first version information is embedded in the verifying definition.

6. The information processing system according to claim 5, the information processing apparatus further comprising a fourth determiner that determines whether the first virtual machine is communicable with the information processing apparatus, wherein
when the fourth determiner determines that the first virtual machine is not communicable with the information processing apparatus, the third determiner determines that the second virtual machine has the same configuration as the first virtual machine.

7. A non-transitory computer-readable recording medium having stored therein a program for causing a computer included in an information processing apparatus to execute a process comprising:
determining, when a second virtual machine of a migration destination is generated from a first virtual machine of a migration source, whether a first generating definition representing a specification of the first virtual machine matches a second generating definition representing a specification of the second virtual machine;
determining whether first version information representing a version of software having been installed in the first virtual machine matches second version information representing a version of software having been installed in the second virtual machine; and
determining, when the first generating definition is determined to matches the second generating definition and the first version information is determined matches the second version information, the second virtual machine has the same configuration as the first virtual machine.

8. The non-transitory computer-readable recording medium according to claim 7, the process further comprising executing a verifying definition including the first version information on the second virtual machine to determine whether the first version information matches the second version information, wherein
the verifying definition is based on the first generating definition, and
the first version information is embedded in the verifying definition.

9. The non-transitory computer-readable recording medium according to claim 7, the process further comprising:
determining whether the first virtual machine is communicable with the information processing apparatus; and
when the first virtual machine is determined not to be communicable with the information processing apparatus,
determining the second virtual machine has the same configuration as the first virtual machine.

10. A method for processing information in an information processing system including a first computer, a second computer, and an information processing apparatus that manages the first computer and the second computer, wherein:
at the second computer,
generating a second virtual machine of a migration destination from a first virtual machine of a migration source expanded in the first computer; and
at the information processing apparatus,
determining, when the second virtual machine is generated, whether a first generating definition representing a specification of the first virtual machine matches a second generating definition representing a specification of the second virtual machine,
determining whether first version information representing a version of software having been installed in the first virtual machine matches second version information representing a version of software having been installed in the second virtual machine, and
determining, when the first generating definition is determined to matches the second generating definition and the first version information is determined to matches the second version information, the second virtual machine has the same configuration as the first virtual machine.

11. The method according to claim 10, further comprising:
executing a verifying definition including the first version information on the second virtual machine to determine whether the first version information is the same as the second version information; wherein
the verifying definition is based on the first generating definition, and
the first version information is embedded in the verifying definition.

12. The method according to claim 11, further comprising:
determining whether the first virtual machine is communicable with the information processing apparatus; and
when the first virtual machine is determined not to be communicable with the information processing apparatus,
determining the second virtual machine has the same configuration as the first virtual machine.
